(19) United States
(12) Patent Application Publication
(10) Pub. No.: US 2020/0025574 A1
(43) Pub. Date: Jan. 23, 2020

(54) Personal Mobility Device having Autonomous Features

(71) Applicant: Robert Bosch GmbH, Stuttgart (DE)

(72) Inventor: Francis Henry Kasperski, III, Brighton, MI (US)

(21) Appl. No.: 16/040,151

(22) Filed: Jul. 19, 2018

(51) Int. Cl. G01C 21/20; G05D 1/00; G05D 1/02; A61G 1/02; A61G 5/10; A61G 7/08; H04W 4/40

(52) U.S. Cl. CPC G01C 21/206; G05D 1/0088; G05D 1/0016; G05D 1/0274; G05D 2201/0206; A61G 5/1051; A61G 7/08; H04W 4/40; A61G 1/0281

(57) ABSTRACT

A personal mobility device may provide mobility assistance to a user, such a user having a disability or impairment. The personal mobility device may comprise autonomous or semi-autonomous functions permitting navigation and maneuvering within complex and dynamic environments. The personal mobility device may be operable to maneuver within an interior or exterior environment. The personal mobility device may utilize navigational data for autonomous or semi-autonomous functions.

### TECHNICAL FIELD

This disclosure relates to personal mobility devices utilized by individuals with disabilities or impaired mobility.

### BACKGROUND

Personal mobility devices may be utilized by individuals having mobility impairments, such as an inability to walk without assistance. Such devices may comprise a variety of configurations, each configuration suited to assist a particular user's individual needs. Personal mobility devices may comprise motorized functions to improve the versatility and range of operation available to the user.

A limitation of personal mobility devices may be difficulty in traversing or navigating unfamiliar areas. Personal mobility devices may be unsuitable for motorized functions in indoor settings.

### SUMMARY

One aspect of this disclosure is directed to a personal mobility device (PMD) comprising autonomous functions carried out by a processor. The PMD may comprise a data store in data communication with the processor and having navigational data usable to plot navigable routes for the PMD. The PMD may comprise a prime mover and steering system operable to maneuver the PMD. Navigable routes may be determined by the processor in response to inputs from a number of sensors, such as an environmental sensor, location sensor, and interactivity sensor. The PMD may comprise a navigation controller operable to control the maneuvering functions of the PMD in response to commands received from the processor, including maneuvering along a navigable route. The PMD may comprise a human-machine interface (HMI) permitting a user to interact with the processor or other components of the MD. The HMI may comprise a conventional interface device such as a keyboard, keypad, or touchscreen display, or may comprise an interface adapted to the particular needs of the user, such as a haptic interface, gaze-detection interface, chin-control interface, mouth-control interface, breath-control interface, or verbal-control interface. Such adapted interfaces may be advantageous to assist users having disabilities. The PMD may comprise a configuration operable to assist a user having particular

Another aspect of this disclosure is directed to a navigation system of a personal mobility device (PMD), comprising a processor and data store operable to determine a navigable route of a PMD in response to inputs from a number of sensors. The number of sensors may comprise an environmental sensor, a location sensor, or an interactivity sensor.

The above aspects of this disclosure and other aspects will be explained in greater detail below with reference to the attached drawings.

### BRIEF DESCRIPTION OF THE DRAWINGS

FIG. 1 is an illustration of a first embodiment of a personal mobility device.

FIG. 2 is a diagrammatic illustration of a process cluster suitable for operating autonomous functions of a personal mobility device.

FIG. 3 is an illustration of a second embodiment of a personal mobility device.

FIG. 4 is an illustration off third embodiment of a personal mobility device.

FIG. 5 is a diagrammatic illustration of a navigation process for a personal mobility device.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

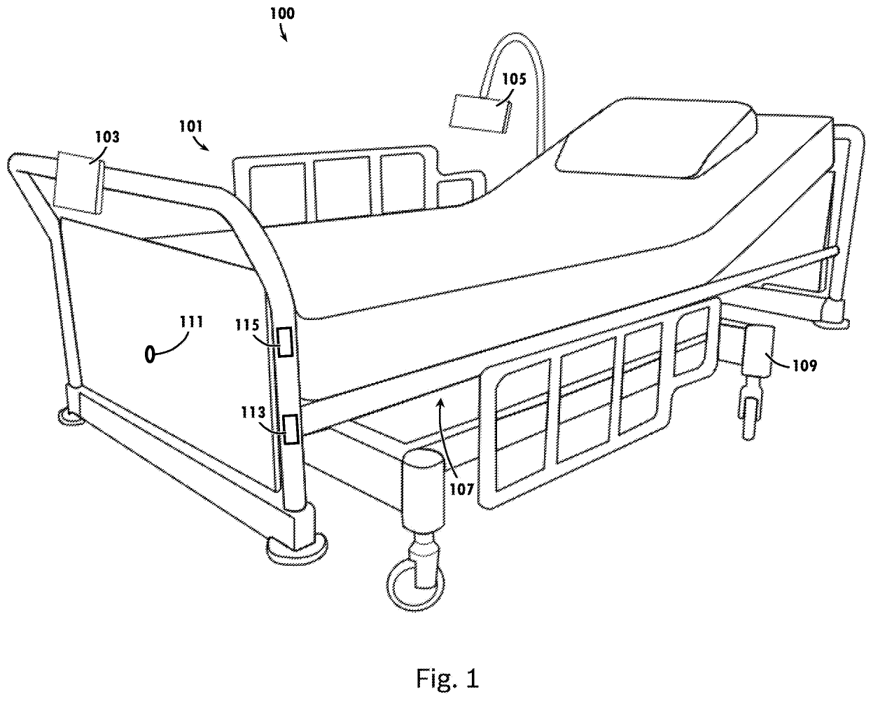

FIG. 1 is an illustration of a personal mobility device (PMD) 100 according to one embodiment of the teachings herein. PMD 100 comprises a chassis 101 operable to support a person requiring mobility assistance. In the depicted embodiment, chassis 101 comprises a hospital bed configured to accommodate a single patient, but other embodiments may comprise other configurations without deviating from the teachings disclosed herein. Other embodiments may comprise a chassis operable to support users in a standing, seated, supine, or prone position without deviating from the teachings disclosed herein. Some embodiments may comprise advanced stability functions configured to provide increased balance and stability of the user or the PMD during operation without deviating from the teachings disclosed herein.

PMD 100 may comprise motorized or autonomous functions, which may be controlled by a process cluster 103. In the depicted embodiment, process cluster 103 may be operable to control adjustments of the chassis 101 to optimize comfort of the user of the PMD 100, but other embodiments may have other or different functions without deviating from the teachings disclosed herein. PMD 100 may further comprise a human-machine interface (HMI) 105 operable to permit a user to interact with process cluster 103. In the depicted embodiment, HMI 105 comprises a control panel disposed upon chassis 101, but other embodiments may comprise other configurations such as a keypad, keyboard, touchscreen controller, or any other alternative known to one of ordinary skill in the art without deviating from the teachings disclosed herein. In some embodiments, HMI 105 may comprise a specialized configuration to accommodate users having particular needs or disabilities, such as a haptic interface, a gaze-detection interface, a chin-controlled interface, a mouth-control interface, a breath-control interface, or a verbal-control interface.

PMD 100 further comprises a prime mover 107 and a steering system 109. Prime mover 107 is operable to provide locomotion of the PMD 100 by propelling the chassis 101. Prime mover 107 may be controlled by process cluster 103. In the depicted embodiment, a user may control prime mover 107 using HMI 105 to access the functions of process cluster 103. In the depicted embodiment, prime mover 107 comprises a battery-powered electric motor operable to propel chassis 101 by rotating a number of wheels affixed thereto, but other embodiments may comprise other configurations without deviating from the teachings disclosed herein. In some embodiments, prime mover 107 may comprise an electric or magnetic propulsion system utilizing a track system. In some embodiments, prime mover 107 may comprise an electric engine powered by an external electric grid. Embodiments utilizing external electricity may be better suited for primarily indoor operation. In some embodiments, prime mover 107 may comprise a combustion engine, utilizing combustible fuel such as gasoline, diesel, a hydrogen fuel cell, or natural gas such as propane or butane. Embodiments utilizing combustion may be better suited for primarily outdoor operation. In some embodiments, a combination of one or more of the above configurations may utilized in a hybrid configuration of prime mover 107. In such hybrid embodiments, processing cluster 103 may be operable to control energy utilization to optimize the utility of the available sources of energy for prime mover 107.

Steering system 109 may be controlled by process cluster 103. In the depicted embodiment, a user may control steering system 109 using HMI 105 to access the functions of process cluster 103. In the depicted embodiment, steering system 109 may comprise a steering mechanism operable to position a number of wheels disposed upon chassis 101 at various angles to facilitate maneuvering of PMD 100 during propulsion by prime mover 107. Other embodiments may comprise other configurations without deviating from the teachings disclosed herein. In some embodiments, steering system 109 may comprise a rail system diverting the direction of motion of PMD 100 during propulsion by prime mover 107.

PMD 100 may comprise a number of sensors operable to provide data to processing cluster 103 that may be useful in controlling prime mover 107 and steering system 109. One or more environmental sensors 111 may be operable to detect the conditions of the environment in which PMD 100 is disposed. Environmental sensor 111 may be operable to detect stationary objects, walls, moving objects, the conditions of floor or ground surfaces, overhead clearance, or other conditions of the environment useful in determining maneuverability and navigation. An environmental sensor 111 may comprise a proximity sensor, a motion sensor, a radar sensor, a lidar sensor, a light-detection sensor, an echolocation sensor, a vibration sensor, a sonic sensor, an infrared sensor, an ultraviolet sensor, or any other alternative sensor known to one of ordinary skill in the art without deviating from the teachings disclosed herein. Some embodiments may comprise an array of environmental sensors 111 without deviating from the teachings disclosed herein. In such embodiments, the array of environmental sensors 111 may comprise a plurality of similar sensors, a combination of sensors of different types, or any combination thereof without deviating from the teachings disclosed herein. In the depicted embodiment, environmental sensor 111 is disposed upon chassis 101, but other embodiments may comprise other configurations, such as one or more environmental sensors 111 disposed within the environment and in data communication with process cluster 103.

PMD 100 may additionally comprise a location sensor 113 operable to determine the location of the PMD with respect to a predetermined localization scheme describing the environment of operation. In some embodiments, location sensor 113 may comprise a global positioning system (GPS) sensor, and the predetermined localization scheme may comprise GPS coordinates. In some embodiments, other location sensor 113 may comprise alternative positioning technology without deviating from the teachings disclosed herein. In some embodiments, location sensor 113 may be operable to detect a system of location beacons placed within the environment that define the associated localization scheme. Such embodiments may be advantageously utilized to support indoor operations of PMD 100. Location sensor 113 may be disposed upon chassis 101 in order to reflect the location of PMD 100 within the environment. In the depicted embodiment, location sensor 113 is disposed upon an anterior portion of chassis 101, but other embodiments may comprise other configurations without deviating from the teachings disclosed herein. In some embodiments, PMD 100 may comprise a plurality of location sensors 113 without deviating from the teachings disclosed herein.

PMD 100 may additionally comprise an interactivity sensor 115. Interactivity sensor 115 may be operable to utilize interactivity signals to monitor the proximity of other signal-generating devices. In the depicted embodiment, interactivity sensor 115 comprises a transceiver operable to both transmit and receive interactivity signals, but other embodiments may comprise other Interactivity sensor 115 may utilize a vehicle-to-environment (V2X) protocol, a vehicle-to-vehicle (V2V) protocol, or a combination of the two protocols, or any other similar interactive protocol to generate interactivity data without deviating from the teachings disclosed herein. In the depicted embodiment, interactivity sensor 115 may be operable to generate interactivity signals to communicate with other similar sensors not associated with PMD 100. Interactivity signals may include beacon signals indicating the presence of the PMD 100 within a local proximity, but other embodiments may utilize other types of signals instead of or in addition to beacon signals without deviating from the teachings herein. Such signals may be utilized in conjunction with signals received by interactivity sensor 115 to coordinate the PMD 100 with other compatible devices within the environment. By way of example and not limitation, PMD 100 may exchange interactivity signals with another mobile device utilizing a V2V protocol in order to prevent unwanted interference of motion for each device, such as a collision. In another example, V2V protocols may be utilized to optimize the navigation of other mobility devices or other compatible vehicles within the environment. In the depicted embodiment, interactivity sensor 115 may be operable to communication with compatible sensors disposed upon stationary objects or devices using a V2X protocol for the purpose of avoiding interference in navigation caused by the stationary objects or devices. By way of example and not limitation, interactivity sensor 115 may be in communication with a compatible sensor disposed upon a door. The communication may provide data to processing cluster 103 indicating whether the door is completely open, partially open, closed and unlocked, closed and locked, or any other status which may render passage through the door suboptimal or impossible for PMD 100. In the depicted embodiment, PMD 100 comprises a single interactivity sensor 115, but other embodiments may comprise a different number of interactivity sensors without deviating from the teachings disclosed herein.

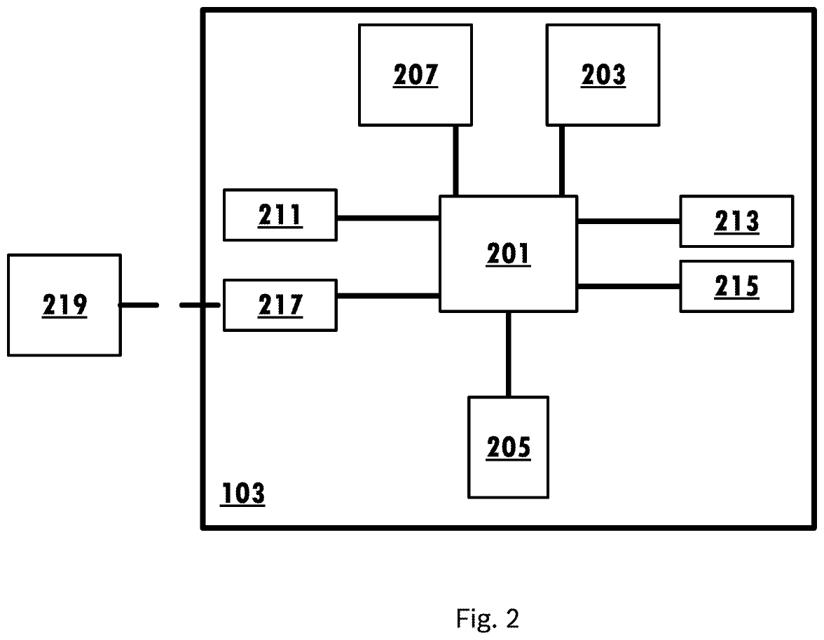

FIG. 2 comprises a diagrammatic illustration of the components of process cluster 103. Process cluster 103 may comprise a processor 201 operable to control functions of process cluster 103, coordinate operations of other components of process cluster 103, or perform calculations useful in analyzing commands or data received by process cluster 103 during operation of the associated PMD. Process cluster 103 may additionally comprise an internal data store 203. Internal data store 203 may comprise instructions for execution by processor 201. Internal data store 203 may further comprise data useful to other components of process cluster 103. In some embodiments, internal data store 203 may be updated with data by processor 201 in order to provide a history of data that may be utilized to improve the operations of processor 201 using a machine-learning algorithm.

Process cluster 103 may comprise a HMI controller 205 operable to provide data communication between processor 201 and a human-machine interface of the associated PMD, such as HMI 105 (see FIG. 1), but other embodiments may comprise other forms of HMI without deviating from the teachings disclosed herein. HMI controller 205 permits processor 201 to transmit and receive data and commands from an associated HMI. Processor 201 may be operable to utilize HMI controller 205 to transmit data from internal data store 203 to an associated HMI.

Process cluster 103 may comprise a navigation controller 207 in data communication with processor 201. Navigation controller 207 permits processor 201 to control maneuvering functions of a prime mover and steering system of the associated PMD, such as prime mover 107 or steering system 109 (see FIG. 1). The maneuvering functions may be controlled by the processor 201 in response to user commands entered using a human-machine interface. The maneuvering functions may be controlled by the processor 201 in response to a request for autonomous or semi-autonomous navigation of the associated PMD.

In response to requests for autonomous or semi-autonomous functions, processor 201 may utilize navigational data indicating routes within the environment that are navigable by the associated PMD. Navigational data may comprise map data defining roadways or walkways navigable by the PMD. The map data may define fixed-obstacles that may impede the PMD during navigation. Fixed-obstacles may be artificial, such as buildings, walls, fountains, sculptures, curbs, barricades, areas of insufficient overhead clearance, or other structures that impede or prevent movement of the PMD. Fixed-obstacles may be natural, such as rocks, trees, or bushes. The examples of fixed-obstacles listed herein are provided by way of example and not limitation.

Map data may comprise internal map data defining navigable areas within buildings or structures such as hospitals, shopping malls, schools, stadiums, concert venues, office buildings, parking structures, or any other indoor environments known to one of ordinary skill to have interior portions thereof suitable for navigation by a PMD. Map data may comprise exterior map data defining roads, pathways, walkways, or other outdoor environments known to one of ordinary skill to have portions thereof suitable for navigation by a PMD. In some embodiments, the navigational data may comprise only one of interior map data or exterior map data. In some embodiments, the navigational data may comprise both interior map data and exterior map data. In some embodiments, navigational data, including any associated map data, may be stored by internal data store 203.

Process cluster 103 may comprise a number of interfaces providing data connection between processor 201 and sensors disposed upon the associated PMD. In the depicted embodiment, process cluster 103 comprises an environmental sensor interface 211, a location sensor interface 213, and an interactivity sensor interface 215. Environmental sensor interface 211 may provide data communication between processor 201 and any environmental sensors associated with the PMD. Location sensor interface 213 may provide data communication between the processor 201 and any location sensors associated with the PMD. Interactivity sensor interface 215 may provide data communication between processor 201 and any interactivity sensors associated with the PMD. In the depicted embodiment, the interfaces may establish a hard-wired connection between processor 201 and the respective associated sensors, but other embodiments may utilize a wireless connection without deviating from the teachings disclosed herein. In some embodiments, some of the interfaces may establish a hard-wired data connection and others may establish a wireless data connection without deviating from the teachings disclosed herein.

Process cluster 103 may comprise a wireless connectivity interface 217 operable to provide wireless connectivity to processor 201. In embodiments featuring wireless data communication between processor 201 and at least one of the sensor interfaces, wireless connectivity interface 217 may be utilized to establish the wireless connections. In the depicted embodiment, wireless connectivity interface 217 provides data communication between processor 201 and an external data source 219. External data source 219 may provide a source of navigational data instead or in addition to navigational data being provided by internal data store 203. In some embodiments, external data source 219 may comprise a database of navigational data that may acquire data from one or more PMDs during navigation in order to compile a history of navigational data for utilization in a machine-learning algorithm.

External data source 219 may additionally comprise data indicating special avoidance areas for portions of the environment having undesirable conditions, such as areas of congestion, areas of undesired environmental conditions, or areas deemed off-limits by authorized parties By way of example and not limitation, areas of congestion may indicate areas having heavy foot traffic, areas having heavy vehicle traffic, areas having heavy PMD traffic, some combination of the above, or any other cause of congestion in an environment known to one of ordinary skill in the art without deviating from the teachings disclosed herein. By way of example and not limitation, areas of undesired environmental conditions may comprise undesirable terrain such as wetness/puddles, snow/ice, dirt/mud, gravel, uneven pavement, potholes, undesirable topography, or any other undesirable terrain condition known to one of ordinary skill without deviating from the teachings disclosed herein. By way of example and not limitation, areas of undesired environmental conditions may comprise temporary conditions, such as spilled refuse, wet paint, exposed power lines, undesirable weather conditions, insufficient shade, or any other temporary condition known to one of ordinary skill in the art without deviating from the teachings disclosed herein. By way of example and not limitation, undesirable environmental conditions may comprise environmental conditions that are suboptimal for the operation of sensors, prime mover, steering system, or another operational component of the PMD.

By way of example and not limitation, areas deemed off-limits by authorized parties may comprise areas restricted by municipal entities, areas restricted by law enforcement, areas restricted by the management of the area, areas restricted by the owners of the area, areas restricted by the occupants of the area, areas temporarily closed for maintenance, areas temporarily closed for renovation, areas temporarily closed for cleaning, or any other restriction known to one of ordinary skill in the art without deviating from the teachings disclosed herein. External data source 219 may comprise data specifying avoidance condition limits. By way of example and not limitation, an area within an environment may be closed nightly for cleaning between 8 pm-9 pm, and external data source 219 may accordingly provide data specifying that the area is closed during this time window, but is otherwise normally open. In the event that the time window is adjusted, external data source 219 may be updated to reflect the change in time window.

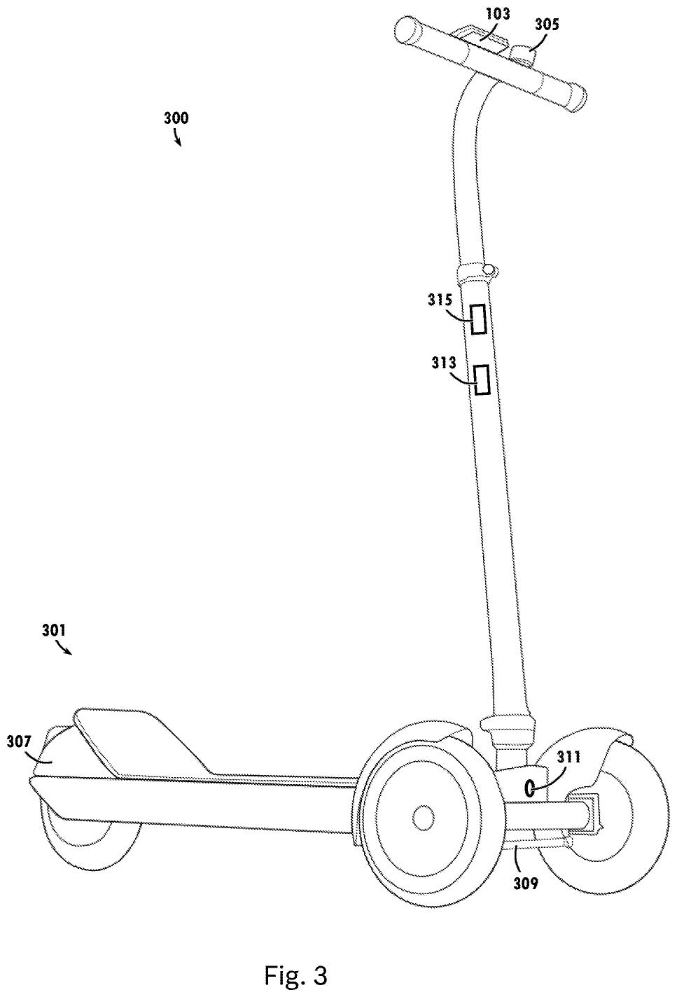

FIG. 3 an illustration of a personal mobility device 300 in the form of a motorized scooter. PMD 300 comprises a processing cluster 103 of the same functionality as depicted with respect to PMD 100 (see FIG. 1). PMD 300 comprises a chassis 301 configured to support a standing rider. PMD 300 comprises a human-machine interface 305, prime mover 307, steering system 309, environmental sensor 311, location sensor 313, and interactivity sensor 315, which may be functionally similar to HMI 105, prime mover 107, steering system 109, environmental sensor 111, location sensor 113, and interactivity sensor 115 respectively, except configured to be disposed with respect to chassis 301 and configured to be operable as a component of PMD 300. PMD 300 may comprise additional features or functions without deviating from the teachings disclosed herein.

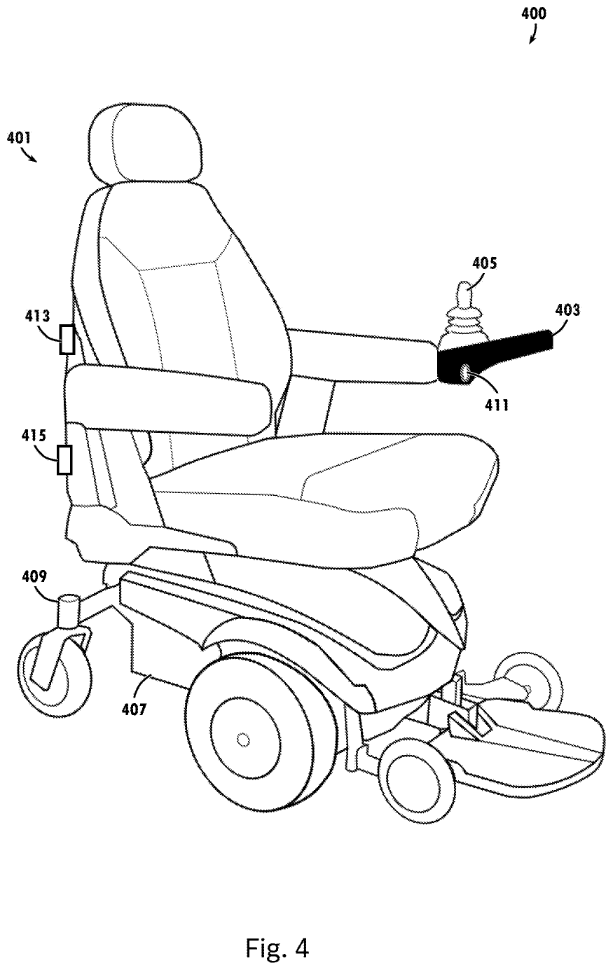

FIG. 4 an illustration of a personal mobility device 400 in the form of a motorized wheelchair. PMD 400 comprises a processing cluster 403 of the same functionality as depicted with respect to PMD 100 (see FIG. 1). PMD 400 comprises a chassis 401 configured to support a rider. PMD 400 comprises a human-machine interface 405, prime mover 407, steering system 409, environmental sensor 411, location sensor 413, and interactivity sensor 415, each of which may be respectively functionally similar to HMI 105, prime mover 107, steering system 109, environmental sensor 111, location sensor 113, and interactivity sensor 115, except configured to be disposed with respect to chassis 401 and configured to be operable as a component of PMD 400. PMD 400 may comprise additional features or functions without deviating from the teachings disclosed herein.

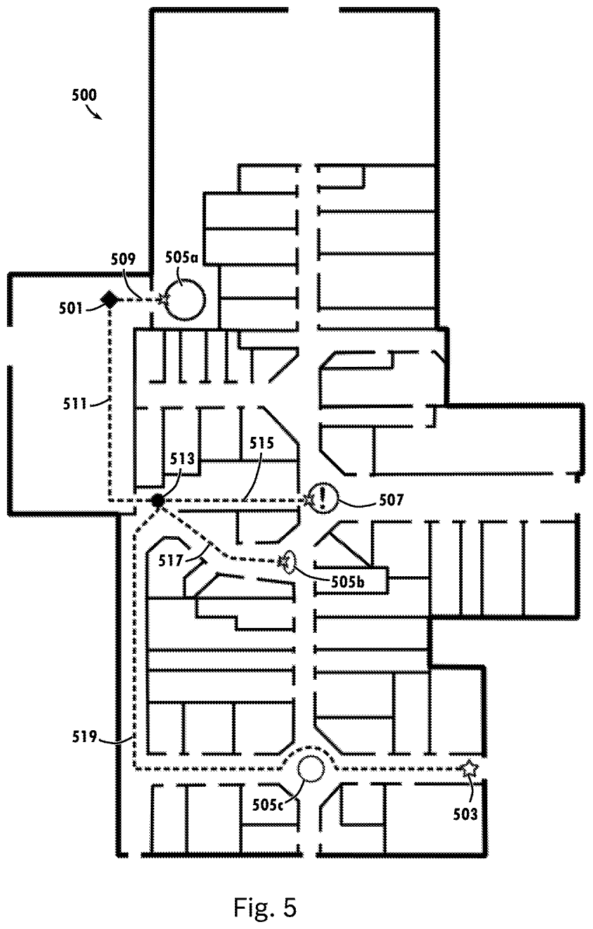

FIG. 5 depicts a diagrammatic illustration of an autonomous navigation plan suitable for a PMD within an environment 500. The autonomous navigation plan may be instantiated by a processor of a PMD, such as a processor 201. The autonomous navigation plan may be executed by a PMD in response to an autonomous navigation request by a user. In the depicted embodiment, environment 500 may comprise a shopping mall, but other embodiments may comprise other environments such as a hospital, school, stadium, concert venue, office building, parking structure, park, playground, city block, roadway, pathway, walkway, a combination of one or more of the above environments, or any other navigable environment known to one of ordinary skill in the art without deviating from the teachings disclosed herein.

The autonomous navigation plan begins at a starting location 501 in a first area of the environment, and determines a route to a destination 503 in a second area of the environment. Within the environment are a number of fixed-obstacles 505 and an avoidance zone 507. Other embodiments may comprise a different number of fixed-obstacles and avoidance zones without deviating from the teachings disclosed herein.

Some of fixed-obstacles 505 may render the areas of environment 500 with which they are associated non-navigable by the PMD. For example, a fixed-obstacle may leave insufficient maneuvering space for the PMD to avoid the fixed-obstacle, or may render a portion of the environment impassable by the PMD. The navigability around a fixed-obstacle will be defined by the specifications of the associated PMD, the properties of the fixed-obstacle, the preferences of the user, and environment in which the fixed-obstacle is found.

An avoidance zone represents an area of environment 500 that is designated such that the PMD will not navigate through the zone for reasons of safety, authorized designation, optimized operation of the PMD, or user preference. For example, an avoidance zone may comprise an area of environment 500 that features heavy congestion which would slow progress of the PMD along the autonomous navigation plan. The navigability of the avoidance zone will be defined by the specifications of the associated PMD, the conditions of the avoidance zone, the preferences of the user, and the environment in which the avoidance zone is found. In some embodiments, an avoidance zone may be navigated if it is defined only by user preference but other areas within the environment are deemed unsafe or less navigable.

In the depicted embodiment, the PMD analyzes the pathways available within environment 500 between starting location 501 and destination 503 and selects one of the pathways for assessment. Pathways may be assessed based upon individual branches of travel, with each branch being particularly assessed according to user preferences. User preferences may comprise priority of branches based upon distance, travel time, ease-of-travel, most favorable conditions, or any other basis for priority recognized by one of ordinary skill in the art without deviating from the teachings disclosed herein. In the depicted embodiment, a first branch 509 and second branch 511 are assessed to be suitable for navigation. First branch 509 is obstructed by fixed-obstacle 505a, which impedes navigation by the PMD. Thus, first branch 509 is eliminated from consideration, and second branch 511 is selected for the autonomous navigation plan.

Second branch 509 terminates at a junction point 513, where additional branches may be utilized en route to destination 503. A third branch 515 may nominally best-fit the user preferences, but currently require passage through an avoidance zone. A fourth branch 517 may be the next-best nominal branch according to the user preferences, but may be obstructed by fixed-obstacle 505b. Thus a fifth branch 519 may be considered as the best possible navigable route for autonomous navigation plan. In the depicted embodiment, fifth branch 519 passes by fixed-obstacle 505c, but the environment is not rendered non-navigable by the PMD because of fixed-obstacle 505c. Thus, in the depicted embodiment, the PMD may maneuver around fixed-obstacle 505c and proceed to destination 503. In response to the above analysis, the autonomous navigation plan may comprise second branch 511 and fifth branch 519. This embodiment is provided by way of example and not limitation, and other environments or PMD configurations may yield other results without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A personal mobility device (PMD) having a chassis operable to carry at least one Person and configured to operate at least indoors comprising:
a processor at least partially disposed upon the chassis;
a data store in data communication with the processor and comprising navigational data usable by the processor to plot a navigable route for the PMD;
a human-machine interface in data communication with the processor and operable to permit a user to access and control the functions of the processor;
a prime mover at least partially disposed upon the chassis and operable to rotate a number of wheels of the PMD;
a steering system at least partially disposed upon the chassis and operable to steer the direction of motion of the PMD;
a navigation controller operable to control the operations of the prime mover and the steering system;
a number of environmental sensors disposed upon the chassis operable to generate environmental data describing the environment in which the PMD is disposed;
a location sensor disposed upon the chassis and operable to generate position data describing the position of the vehicle using a coordinate scheme; and
an interactivity sensor at least partially disposed upon the chassis operable to detect other interactivity sensors not associated with the PMD,
wherein the processor is in data communication with the navigation controller, the number of environmental sensors, the location sensor, and the interactivity sensor and is operable to utilize data from the data store and data gathered by the number of environmental sensors, location sensor, and interactivity sensors to operate the prime-mover controller according to a plotted navigable route.

2. The PMD of claim 1, wherein the human-machine interface comprises at least one of a touchscreen display, a keyboard input device, a keypad input device, or a control panel.

3. The PMD of claim 1, wherein the human-machine interface comprises at least one of a haptic interface, a gaze-detection interface, a chin-control interface, a mouth-control interface, a breath-control interface, or a verbal-control interface.

4. The PMD of claim 1, wherein the navigational data comprises exterior map data defining the locations of roadways and walkways navigable by the PMD.

5. The PMD of claim 4, wherein the exterior map data further defines fixed-obstacles that render portions of roadways or walkways non-navigable by the PMD.

6. The PMD of claim 1, wherein the navigational data comprises interior map data defining the locations of interior walkways and passages inside buildings and navigable by the PMD.

7. The PMD of claim 6, wherein the interior map data further defines fixed-obstacles that render portions of interior walkways or passages inside buildings non-navigable by the PMD.

8. The PMD of claim 1 wherein the interactivity sensor comprises a vehicle-to-environment (V2X) transceiver operable to detect environmental beacons and other V2X transceivers associated with other vehicles.

9. The PMD of claim 1, wherein the processor is further operable to generate new navigational data to be stored in the data store based upon the conditions encountered by the PMD.

10. The PMD of claim 1, wherein the data store at least partially comprises a cloud-based storage in remote data communication with the processor.

11. The PMD of claim 10, wherein the data store is in remote data communication with a number of other processors.

12. The PMD of claim 11, wherein at least one of the number of other processors is associated with a vehicle.

13. The PMD of claim 10, wherein the processor is further operable to modify the operation of the navigation controller in response to updates in the navigational data.

14. A navigation system comprising:
a processor in data communication with a prime mover and a steering system of a personal mobility device;
a data store in data communication with the processor and comprising navigational data usable by the processor to plot a navigable route for the personal mobility device;
a number of environmental sensors in data communication with the processor and operable to measure conditions of an environment in which the personal mobility device is disposed;
a location sensor in data communication with the processor and operable to generate position data describing the position of the personal mobility device using a coordinate scheme; and
an interactivity sensor in data communication with the processor and operable to detect other interactivity sensors associated with other mobility devices,
wherein the environmental, sensors, location sensor and interactivity sensor are operable to be installed in the personal mobility device.

15. The navigation system of claim 14, wherein the personal mobility device comprises at least one of a wheelchair and a bed.

16. The navigation system of claim 14, wherein the personal mobility device comprises a motorized scooter.

17. The navigation system of claim 14, wherein the interactivity sensor comprises a vehicle-to-vehicle (V2V) sensor operable generate beacon signals indicating the presence of the personal mobility device and to detect beacon signals generated by other V2V sensors associated with other mobility devices.

18. The navigation system of claim 14, wherein the interactivity sensor comprises a vehicle-to-environment (V2X) transceiver operable to detect environmental beacons and other V2X transceivers associated with other mobility devices.

19. The navigation system of claim 14, wherein the navigational data comprises map data defining pathways and walkways navigable by the personal mobility device.

20. The navigation system of claim 19, wherein the map data further comprises interior map data defining pathways and walkways navigable by the personal mobility device inside of buildings.
